(19) United States
(12) Patent Application Publication
(10) Pub. No.: US 2025/0324491 A1
(43) Pub. Date: Oct. 16, 2025

(54) INDUCTION COOKTOP

(71) Applicant: SMEG S.P.A., Guastalla (Re) (IT)

(72) Inventors: Emanuele BARBIERI, Guastalla (Re) (IT); Alberto Dall'oglio, Guastalla (Re) (IT); Costanza Gaiga, Guastalla (Re) (IT); Lorenzo RASCHI, Guastalla (Re) (IT)

(73) Assignee: SMEG S.P.A., Guastalla (Re) (IT)

(21) Appl. No.: 19/097,183

(22) Filed: Apr. 1, 2025

(30) Foreign Application Priority Data
Apr. 12, 2024 (IT) 102024000008344

(51) Int. Cl. H05B 6/12

(52) U.S. Cl. CPC H05B 6/1209

(57) ABSTRACT

An induction cooktop comprising a ceramic glass comprising an outer cooking face provided with one or more cooking zones, and an inner face opposite the cooking face coupled with one or more corresponding induction heating sources, a perimeter frame running along a side edge of the ceramic glass and projecting beyond the inner face of the ceramic glass towards a support intended to support the cooktop, a perimeter seal projecting beyond the perimeter frame and configured to make contact with the support surface such that the frame and the ceramic glass are raised from the support to create at least one chamber between the cooktop and the support that is insulated from the outside by the perimeter seal, and at least one light source in the chamber, wherein the perimeter seal is made of a material that allows light to exit from the chamber and illuminate the support.

### CROSS-REFERENCE TO RELATED APPLICATION

This patent application claims priority from Italian patent application no. 102024000008344 filed on Apr. 12, 2024, the entire disclosure of which is incorporated herein by reference.

### TECHNICAL FIELD

The present invention relates to an induction cooktop. In particular, the present invention offers a solution to the problem of producing a cooktop provided with innovative and integrated lighting.

### BACKGROUND

As is known, induction cooktops are available on the market. These devices usually comprise a ceramic glass coupled with a support surface. This ceramic glass comprises an outer cooking face provided with one or more cooking zones and an inner face opposite the cooking face coupled with one or more corresponding induction heating sources. Illumination of the cooktop and of the support surface to which it is constrained is currently delegated solely to external light sources, usually positioned above the cooktop.

The object of the present invention is to offer an induction cooktop provided with innovative and integrated lighting, which can supplement the known external ambient light.

### SUMMARY

According to the present invention, there is provided an innovative induction cooktop of the type comprising:
a ceramic glass (preferably rectangular in shape with rounded edges) comprising an outer cooking face provided with one or more cooking zones (preferably delimited by specific delimitation lines on the cooking face) and an inner face opposite the cooking face coupled with one or more corresponding induction heating sources;
a perimeter frame (preferably metal) running along the side edge, preferably the entire side edge, of the ceramic glass; this frame on one side is preferably flush with the cooking face of the ceramic glass and on the other side is projecting beyond the inner face of the ceramic glass towards a support surface (for example a table or a worktop) intended to support the induction cooktop;
a perimeter seal projecting beyond the perimeter frame (for example coupled to the frame in a specific seat produced in the frame) and configured to make contact with the support surface positioning itself between frame and support; in this way the frame and the ceramic glass inside it are raised from the support surface to create at least one inner chamber between the induction cooktop and the support surface that is insulated from the outside by the perimeter seal. Even more preferably, the seal is not flush with the lower outer edge of the frame but is in a backward position (for example flush with the lower inner edge of the frame) so that the cooktop appears to the eye to be floating on the support surface and the seal is not visible.

Therefore, according to the present invention the ceramic glass is neither flush with the support surface nor resting thereon (being supported by the frame to which it is constrained), the frame does not rest directly thereon but, due to the position of the seal, the cooktop remains raised from the support surface creating between them an inner chamber insulated from the outside (and in particular from liquids) by the seal.

In this configuration at least one light source is provided housed in this inner chamber between the cooktop and the support surface (i.e., between frame/glass/seal assembly and support surface), which can be directly or indirectly constrained to the cooktop or to the support surface. The perimeter seal is appropriately made of transparent material or in any case of material that allows light to exit from the inner chamber and illuminate at least partially the support surface at the lower edge of the induction cooktop. Therefore, according to the present invention, as well as performing its insulating function, the seal also acts as light guide to guide the light from the inner chamber towards the support surface around the lower edge of the cooktop.

Preferably, the light source is supported by a U-shaped support constrained to the inner face of the glass and/or to the inner face of the frame, wherein this U-shaped support is open toward the support surface, preferably the support runs along the entire outer edge of the inner face of the ceramic glass.

Preferably, a plurality of light sources, even more preferably LED light sources, are provided, substantially along the entire U-shaped support. In this case, the light produced that is projected onto the support surface from the lower edge of the surface is of homogeneous and diffuse type without local peaks. Again in this example, preferably the plurality of LED light sources are supported by a metal material support, preferably a flexible aluminum strip, constrained, preferably by screws, to the U-shaped support (preferably also made of metal). Metal material is advantageous in terms of dissipation of the heat produced by the LEDs. Again in this embodiment, preferably, a U-shaped support comprises one side in contact with the perimeter frame and one base side in contact with the outer edge of the lower face of the ceramic glass. The base side in contact with the ceramic glass is provided with a plurality of holes for the passage of silicone used to constrain the U-shaped support, glass and frame to one another (and to prevent infiltrations of liquids).

Preferably, the induction cooktop of the present invention can comprise an integrated extractor, i.e., a raised or raisable portion of the ceramic glass joined to the rest of the ceramic glass by means of perforated grid walls. A suction fan (preferably housed in the inner chamber under the ceramic glass) is also provided to force cooking fumes to pass through the perforated grid walls towards the inner chamber. Even more preferably, the raised portion of the ceramic glass is movable to move from the raised suction position to a resting position flush with the rest of the ceramic glass.

Finally, for the purpose of greater clarity, the present invention can also comprise the support surface that supports the cooktop as described above to produce an innovative induction cooking assembly.

### BRIEF DESCRIPTION OF THE DRAWINGS

For a better understanding of the present invention an embodiment will now be described purely by way of non-limiting example, with reference to the accompanying drawings, wherein:

FIGS. 1 and 2 are schematic views of two opposite faces of the induction cooktop according to the present invention;

FIG. 3 is an enlarged view of a detail of FIG. 2;

FIG. 4 is a section view of the cooktop of FIG. 1 resting on a support surface;

FIG. 5 shows an example of embodiment in which the cooktop also comprises an extractor; and

FIG. 6 shows the cooktop of FIG. 5 installed on the relative support surface.

### DETAILED DESCRIPTION

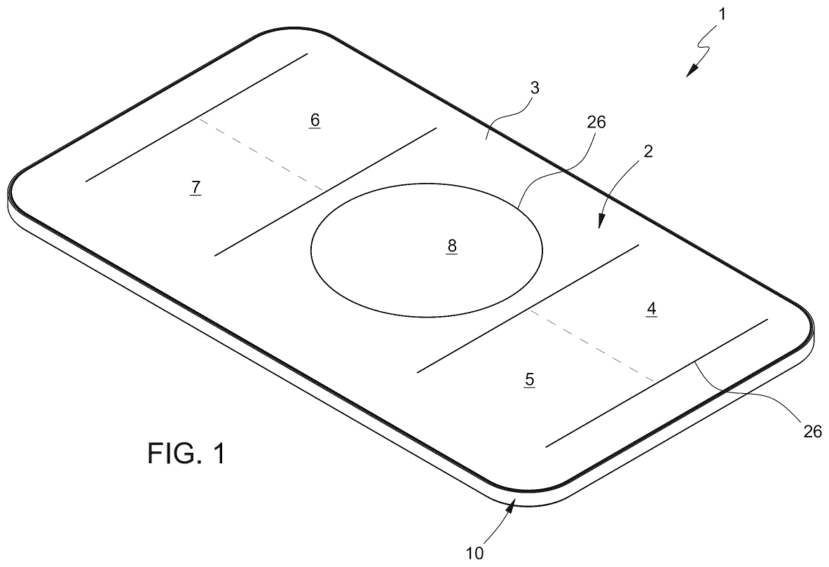

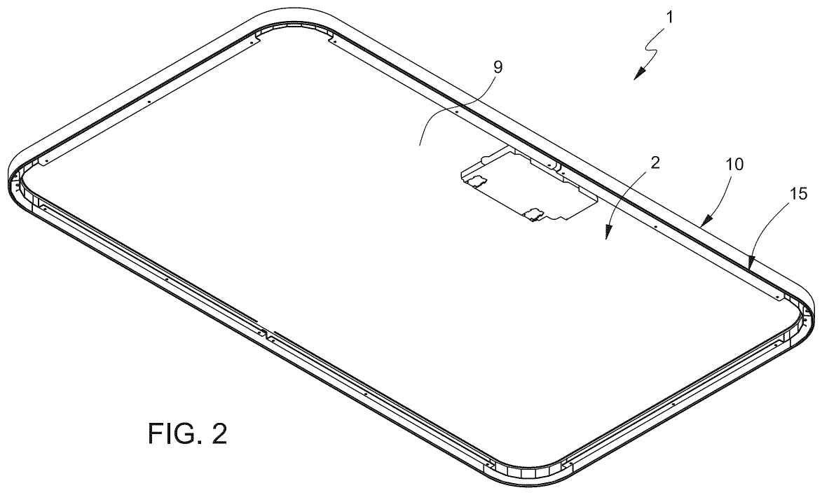

FIGS. 1 and 2 are schematic views of two opposite faces of an example of embodiment of an induction cooktop according to the present invention. In particular, the induction cooktop 1 of FIG. 1 comprises a ceramic glass 2 of rectangular shape with a cooking face 3 divided (by specific indications 26) into a plurality of cooking zones 4-8. The reference 10 identifies a metal frame running along the entire side edge of the ceramic glass 2. Although not shown, the cooking face 3 also comprises controls of the cooking zones and/or a user interface (see reference 25 in FIG. 6). FIG. 2 shows the opposite face 9 of the ceramic glass 3. According to the example of FIG. 2 the frame 10 projects beyond this face 9 and along the edge of the face 9 at the frame 10 there is a U-shaped metal support 15.

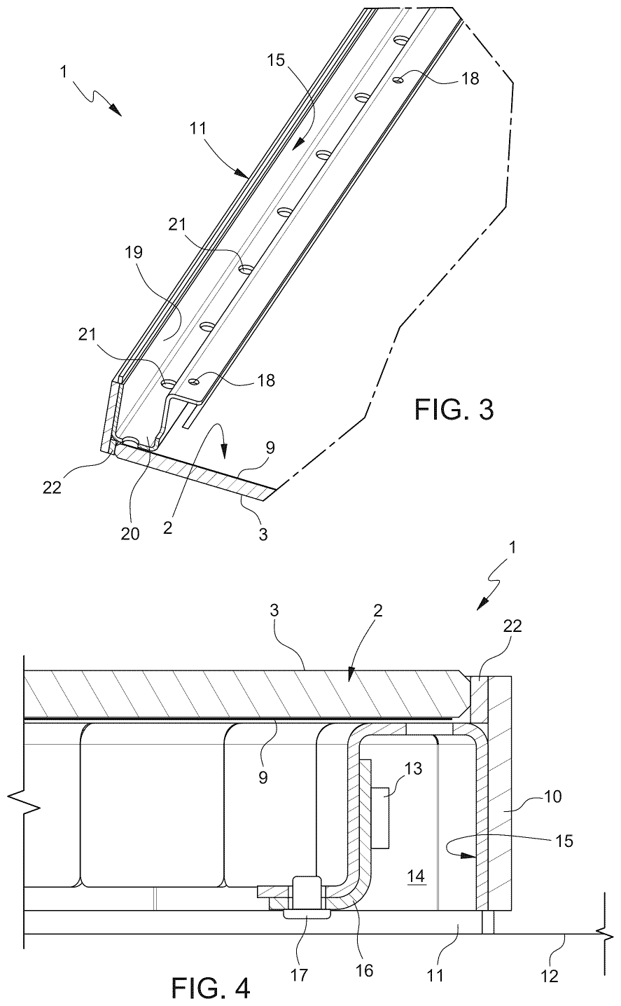

FIG. 3 is an enlarged view of a detail of FIG. 2, i.e., an angular portion of the cooktop 1. This figure shows how the frame 10 is flush with the outer face 3 while projecting beyond the inner face 9. It can also be noted how the U-shaped structure 15 has one side 19 in contact with the inner face of the frame 10 that ends flush with it. A seal 11 that runs along the entire frame 10 projects from the edge of the frame 10 on the side of the inner face 9. The side 21 of the structure 15 is coupled with the edge of the inner face 9 of the glass 2 by silicone that by seeping penetrates the holes 21 and also joins the frame 10 to the glass 2. The reference 22 identifies a second seal placed between the side edge of the glass 2 and the frame 10 (which can also be made of constraining material, such as silicone, which penetrates from the inner face of the ceramic glass). The holes 18 shown in the figure obtained on a folded edge of the structure 15 parallel to the glass are used as seats for screws 17 to secure an L-shaped metal support 16 with a plurality of LEDs 13 in place. The metal support is flexible and runs along the entire structure 15 coupled to the side of the structure opposite the side 19.

FIG. 4 is a section view of the cooktop of FIG. 1 resting on a support surface 12. It can be noted how the glass 2 and the frame 10 do not rest directly on the surface 12 but are raised due to the seal 11. Therefore, an inner chamber 14 is created between the induction cooktop and the support surface 12 wherein the LEDs 13 are housed in this chamber 14. In this example, the seal 11 is in an internal position relative to the outer edge of the frame 10 and in this way is not visible and the cooktop 1 appears to float on the surface 12 without contact.

Advantageously, the seal 11 is made of transparent material or in any case material through which light can pass (a sort of “seal/light guide”) and hence once the LEDs are switched on the light diffused in the chamber 14 exits from the seal 11 and illuminates the surface 12 along the entire edge of the cooktop 1. This effect is shown in FIG. 6. Naturally, although not shown, the electronics required to control and operate the LEDs 13 and to control and operate the heating zones are present.

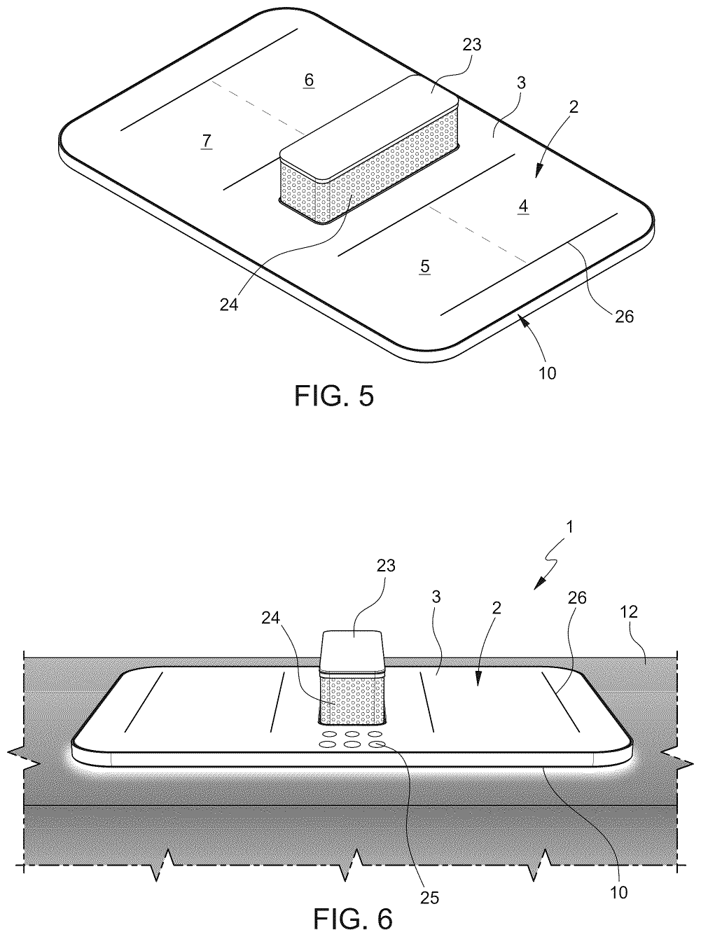

Finally, FIG. 5 shows an example of embodiment in which the cooktop 1 comprises, integrated, not only the lighting but also an extractor 23. In this example the extractor 23 is none other than a portion of the glass 2 in raised position and connected to the rest of the glass 2 by perforated grid walls 24. Naturally, in this example the chamber 14 also houses a suction fan and is provided with suitable control electronics.

Finally, it is clear that modifications and variations can be made to the induction cooktop as described and illustrated herein in an embodiment thereof, without departing from the scope of protection of the present invention, as defined in the appended claims.

1. An induction cooktop, comprising:
a ceramic glass, comprising:
an outer cooking face provided with one or more cooking zones;
a side edge; and
an inner face opposite the cooking face coupled with one or more corresponding induction heating sources;
a perimeter frame running along the side edge of the ceramic glass and projecting beyond the inner face of the ceramic glass toward a support surface intended to support the induction cooktop;
a perimeter seal projecting beyond the perimeter frame and configured to make contact with the support surface such that the frame and the ceramic glass inside it are raised from the support surface to create at least one inner chamber between the induction cooktop and the support surface that is insulated from the outside by the perimeter seal; and
at least one light source in the inner chamber between the cooktop and the support surface, wherein the perimeter seal is made of material that allows light to exit from the inner chamber and illuminate at least partially the support surface at the induction cooktop.

2. The induction cooktop as claimed in claim 1, wherein a U-shaped support open toward the support surface at the edge of the inner face of the ceramic glass is provided, the at least one light source being housed in the U-shaped support.

3. The induction cooktop as claimed in claim 2, wherein the U-shaped support is open toward the support surface along the entire edge of the inner face.

4. The induction cooktop as claimed in claim 2, wherein a plurality of LED light sources are provided along the entire U-shaped support.

5. The induction cooktop as claimed in claim 4, wherein the plurality of LED light sources are supported by a metal material support constrained to the U-shaped support.

6. The induction cooktop as claimed in claim 5, wherein the metal material comprises a flexible aluminum strip.

7. The induction cooktop as claimed in claim 5, wherein the metal material supports is attached to the U-shaped support by screws.

8. The induction cooktop as claimed in claim 2, wherein the U-shaped support comprises one side in contact with the perimeter frame and one side in contact with the ceramic glass, the side in contact with the ceramic glass being provided with a plurality of holes for the passage of silicone.

9. The induction cooktop as claimed in claim 1, wherein a second perimeter seal is provided between the perimeter frame and the ceramic glass.

10. The induction cooktop as claimed in claim 1, wherein the perimeter frame is substantially flush or slightly set back from the cooking face of the ceramic glass.

11. The induction cooktop as claimed in claim 1, wherein the ceramic glass comprises a raised portion joined to the rest of the ceramic glass by means of perforated grid walls, a suction fan being provided to force cooking fumes to pass through the perforated grid walls.

12. The induction cooktop as claimed in claim 11, wherein the raised portion is a central raised portion.

13. The induction cooktop as claimed in claim 11, wherein the raised portion is movable to move from the raised suction position to a resting position flush with the rest of the ceramic glass.

14. The induction cooktop as claimed in claim 1, wherein the frame comprises a lower outer edge, and wherein the seal is not flush with the lower outer edge of the frame but is in a backward position.

15. The induction cooktop as claimed in claim 14, wherein the frame comprises a lower inner edge, and wherein the seal is flush with the lower inner edge of the frame.

16. The induction cooktop as claimed in claim 1, wherein the perimeter frame runs along the entire side edge of the ceramic glass.

17. The induction cooktop as claimed in claim 1, wherein the perimeter seal is translucent.

18. An induction cooktop, comprising:
a ceramic glass, comprising:
an outer cooking face comprising a cooking zone;
a side edge; and
an inner face opposite the cooking face;
an induction heating source engaged with the inner face;
a perimeter frame running along the side edge of the ceramic glass and projecting beyond the inner face of the ceramic glass toward a support intended to support the induction cooktop;
a perimeter seal projecting beyond the perimeter frame and configured to make contact with the support such that the frame and the ceramic glass are raised from the support to create an inner chamber between the induction cooktop and the support that is insulated from the outside by the perimeter seal; and
a light source in the inner chamber between the cooktop and the support, wherein the perimeter seal is made of material that allows light to exit from the inner chamber and at least partially illuminate the support.
